(19) United States
(12) Patent Application Publication
(10) Pub. No.: US 2016/0049258 A1
(43) Pub. Date: Feb. 18, 2016

(54) ELECTRICITY STORAGE DEVICE, PROCESS FOR PRODUCING THE SAME, AND DEVICE FOR PRODUCING THE SAME

(71) Applicant: KOJIMA INDUSTRIES CORPORATION, Toyota-Shi (JP)

(72) Inventors: Yoichiro KOJIMA, Toyota-Shi (JP); Kensuke SUENAMI, Toyota-Shi (JP)

(21) Appl. No.: 14/924,043

(22) Filed: Oct. 27, 2015

Related U.S. Application Data
(63) Continuation of application No. PCT/JP2013/062722, filed on May 1, 2013.

(51) Int. Cl. H01G 4/30; H01G 4/02; H01G 4/012; H01G 4/005

(52) U.S. Cl. CPC H01G 4/306; H01G 4/005; H01G 4/02; H01G 4/012

(57) ABSTRACT

An electricity storage device constituted by a stack of a plurality of electricity storage elements superposed on each other and two external electrodes formed on respective opposite side surfaces of the stack, wherein each of the plurality of electricity storage elements has a basic unit obtained by alternately superposing at least one electricity storage film and a plurality of internal electrode films on each other, and two protective films which have an electrical insulation property and which are superposed on respective opposite surfaces of the basic unit as seen in a direction of superposition of the at least one electricity storage film and the plurality of internal electrode films, and the two external electrodes are formed so as to bridge corresponding side surfaces of adjacent ones of the plurality of electricity storage elements.

### CROSS REFERENCE TO RELATED APPLICATION

This application is a continuation of the International Application No. PCT/JP2013/062722 filed on May 1, 2013, the entireties of which are incorporated herein by reference.

### BACKGROUND OF THE INVENTION

1. Field of the Invention

The present invention relates to an electricity storage device, a process and a device for producing the electricity storage device, a film capacitor, and a process and a device for producing the film capacitor. The present invention relates more particularly to improvements in a stacked electricity storage device and a stacked film capacitor which are formed by using basic units each having a structure in which at least one electricity storage film and a plurality of internal electrode films are alternately superposed on each other, and processes and devices which permit advantageous production of the stacked electricity storage device and the stacked film capacitor.

2. Description of Related Art

An electricity storage device such as a capacitor and a secondary battery has been used for various electronic devices and electric devices. In recent years, there is a demand for compact construction of the electricity storage device, keeping pace with an increased demand for downsizing of the electronic and electric devices. Therefore, in the recent electronic and electric devices, there has been used the electricity storage device which is formed by using a stack having a structure in which at least one electricity storage film and a plurality of internal electrode films are alternately superposed on each other. This electricity storage device can satisfy the demand for downsizing of the electronic and electric devices.

Namely, in the electronic and electric devices required to be downsized, a stacked film capacitor as disclosed in JP-A-9-153434 is used as the capacitor which is a kind of the electricity storage device, for example. This film capacitor is formed by using a basic unit obtained by superposing metallized films on each other. Each of the metallized films is constituted by a dielectric film in the form of a resin film and a vapor-deposited metal film provided on one of opposite major surfaces of the resin film. The metallized films are superposed on each other such that the resin films and the vapor-deposited metal films are alternately arranged. Alternatively, the film capacitor is formed by using a basic unit obtained by superposing metallized films and resin films on each other. Each of the metallized films is constituted by a resin film and vapor-deposited metal films provided on the respective opposite major surfaces of the resin film. The metallized films and the resin films which are not provided with the vapor-deposited metal films are superposed on each other such that the resin films and the vapor-deposited metal films are alternately arranged. A film capacitor element is formed by superposing protective films on surfaces of the basic unit, which surfaces are opposite to each other in the direction of superposition of the metallized films. The film capacitor is obtained by forming external electrodes on two side surface of the film capacitor element, which side surfaces are opposite to each other in a direction perpendicular to the direction of superposition of the metallized films.

On the other hand, JP-A-2011-181885 proposes a film capacitor formed by: using a basic unit including vapor-deposited metal films and dielectric films in the form of vapor-deposited polymer films each of which can be formed with a thickness on the order of nanometer; superposing protective films on respective opposite surfaces of the basic unit as seen in the direction of superposition of the vapor-deposited metal films and the dielectric films, thereby forming a film capacitor element; and forming external electrodes on two opposite side surfaces of the film capacitor element. This film capacitor can have a smaller size than the above-described film capacitor.

Namely, the conventional stacked film capacitor as a kind of the electricity storage device is generally formed by: using a basic unit having a structure in which at least one dielectric film as an electricity storage film and a plurality of vapor-deposited metal films as internal electrode films are alternately superposed on each other; superposing protective films having an electrical insulation property on surfaces of the basic unit, which surfaces are opposite to each other in the direction of superposition of the at least one dielectric film and the vapor-deposited metal films, thereby obtaining a film capacitor element (electricity storage unit); and forming the external electrodes on two opposite side surfaces of the film capacitor element.

By the way, a capacitance of the conventional stacked film capacitor is generally controlled by the numbers of the dielectric films and the vapor-deposited metal films, which are superposed on each other to constitute the basic unit. Namely, in the film capacitor formed by using the basic unit constituted by the metallized films superposed on each other, the capacitance of the film capacitor is determined by the number of the metallized films superposed on each other between the two protective films of the film capacitor element. Accordingly, in the case where there is a need to produce plural kinds of stacked film capacitor having respective different capacitance values by using the metallized films, the plural kinds of film capacitor have been produced by using respective different numbers of the metallized films, depending on the capacitances required for the respective film capacitors.

However, where the film capacitor has a single film capacitor element and the capacitance of the film capacitor is determined depending on the number of the metallized films (numbers of the dielectric films and the vapor-deposited metal films of the basic unit) superposed on each other to constitute the film capacitor element, there arise inherent problems as described below due to the structure of the film capacitor.

Namely, the size of the single film capacitor element increases with an increase of the capacitance required for the film capacitor, since the required number of the metallized films increases with the increase of the capacitance required for the film capacitor. Therefore, where there is a need to produce the plural kinds of film capacitor having respective different capacitance values, the film capacitors are generally produced by using a device for forming the film capacitor element and a device for forming the external electrodes, which devices are configured to produce the film capacitor having the largest number of the metallized films. The device for forming the film capacitor element is configured to form a single film capacitor element by superposing the metallized films on each other to form the basic unit and superposing the protective films on the respective opposite surfaces of the basic unit as seen in the direction of superposition of the metallized films, while the device for forming the external electrodes is configured to form the external electrodes on the two opposite side surfaces of the single capacitor element produced as described above. The above-described devices configured to produce the film capacitor having the largest number of the metallized films are used for production of both of the film capacitor having the largest number of the metallized films and other film capacitors having smaller numbers of the metallized films. Therefore, setting of the device for forming the film capacitor element regarding the number of superposition of the metallized films need to be changed depending on the kind (capacitance) of the film capacitor to be obtained, and equipment and operating conditions also need to be changed depending on the kind of the film capacitor, giving rise to a risk of deterioration of efficiency of production of the film capacitor. Moreover, there is a further disadvantage that new equipment is required to produce the film capacitor which has a higher capacitance and which is difficult to be produced by using the existing equipment.

In addition, the conventional film capacitor is configured such that when an insulation breakdown takes place within the film capacitor element, a self-recovery function is performed by the single dielectric film in which the insulation breakdown took place. However, the conventional film capacitor is not configured to prevent a progress of the insulation breakdown in the direction of the thickness of the film capacitor element (direction of superposition of the dielectric films and the vapor-deposited metal films).

Problems similar to those described above with respect to the film capacitor are also inherent in other electricity storage devices formed by using the basic unit having the structure in which at least one dielectric film and a plurality of internal electrode films are superposed on each other. Examples of those other electricity storage devices include an all-solid secondary battery and an air secondary battery which are produced by using lithium, magnesium, calcium, iron, zinc and the like as positive-electrode active substances, negative-electrode active substances and electrodes.

### SUMMARY OF THE INVENTION

The invention was made in view of the background art described above. An object of the invention is to provide an improved structure of a stacked electricity storage device configured so as to permit more efficient production of plural kinds of electricity storage device having respective different capacitance values, without the need to modify production equipment and the need to employ new production equipment, and so as to advantageously prevent the progress of the insulation breakdown in the direction of its thickness. Further objects of the invention are to provide a process and a device which permit advantageous production of the stacked electricity storage device described above. Another object of the invention is to provide an improved structure of a stacked film capacitor configured so as to permit more efficient production of plural kinds of film capacitor having respective different capacitance values, without the need to modify production equipment and the need to employ new production equipment, and so as to advantageously prevent the progress of the insulation breakdown in the direction of its thickness. Further objects of the invention are to provide a process and a device which permit advantageous production of the stacked film capacitor described above.

The above-described object can be achieved according to the invention, which provides an electricity storage device characterized in that the electricity storage device is constituted by a stack of a plurality of electricity storage elements superposed on each other and two external electrodes formed on respective opposite side surfaces of the stack, wherein each of the plurality of electricity storage elements has a basic unit obtained by alternately superposing at least one electricity storage film and a plurality of internal electrode films on each other, and two protective films which have an electrical insulation property and which are superposed on respective opposite surfaces of the basic unit as seen in a direction of superposition of the at least one electricity storage film and the plurality of internal electrode films, and the two external electrodes are formed so as to bridge corresponding side surfaces of adjacent ones of the plurality of electricity storage elements. In this respect, it is noted that the term “electricity storage film” used herein means a thin film which is interposed between two internal electrode films and which has a structure that can store electricity. Examples of the electricity storage film include a dielectric film, an organic solid electrolyte film and an inorganic solid electrolyte film. Further, the term “internal electrode film” used herein means a thin film formed of a metallic material.

According to a preferable form of the invention, the electricity storage device is a film capacitor, an all-solid secondary battery or an air secondary battery.

According to a preferable form of the invention, at least one of the plurality of internal electrode films is constituted by a vapor-deposited metal film, a metallic sputtering film or a metallic CVD film.

To achieve the above-described object, the invention also provides a process for producing an electricity storage device, characterized by comprising the steps of: (a) providing a plurality of electricity storage elements each obtained by using a basic unit having a structure in which at least one electricity storage film and a plurality of internal electrode films are alternately superposed on each other, and superposing two protective films having an electrical insulation property on respective opposite surfaces of the basic unit as seen in a direction of superposition of the at least one electricity storage film and the plurality of internal electrode films; (b) selecting at least two electricity storage elements from the thus provided plurality of electricity storage elements; (c) superposing the selected at least two electricity storage elements on each other to form a stack of those electricity storage elements; and (d) forming two external electrodes on respective opposite side surfaces of the stack, such that the external electrodes bridge corresponding side surfaces of adjacent ones of the at least two electricity storage elements.

According to a preferable form of the invention, the step of providing the plurality of electricity storage elements comprises: continuously moving a first strip member giving one of the two protective films superposed on the respective opposite surfaces of the basic unit, in a longitudinal direction of the first strip member; placing a plurality of basic units on the first strip member being continuously moved, such that one of the respective opposite surfaces of each basic unit as seen in the direction of superposition of the at least one electricity storage film and the plurality of internal electrode films is in contact with the first strip member, and such that the plurality of basic units are spaced apart from each other by a predetermined distance in the direction of movement of the first strip member; continuously moving a second strip member giving the other of the above-described two protective films in a longitudinal direction of the second strip member, such that the second strip member covers the plurality of basic units placed on the first strip member, whereby the plurality of basic units held between the first and second strip members are continuously carried by the first and second strip members; and cutting the first and second strip members at positions on respective upstream and downstream sides of each of the plurality of basic units as seen in the direction of movements of the first and second strip members, thereby successively producing the plurality of electricity storage elements.

According to a preferable form of the invention, a pressure is applied to a laminar member consisting of the first and second strip members and the plurality of basic units held between the first and second strip members while the laminar member is continuously carried, before the first and second strip members are cut.

To achieve the above-described object, the invention also provides a device for producing an electricity storage device, characterized by comprising: (a) electricity-storage-element forming means for forming each of a plurality of electricity storage elements by using a basic unit obtained by alternately superposing at least one electricity storage film and a plurality of internal electrode films on each other, and superposing two protective films having an electrical insulation property on respective opposite surfaces of the basic unit as seen in a direction of superposition of the at least one electricity storage film and the plurality of internal electrode films; (b) stack forming means for superposing at least two of the thus formed plurality of electricity storage elements on each other, thereby forming a stack of the at least two electricity storage elements; and (c) external-electrode forming means for forming two external electrodes on respective opposite side surfaces of the stack, such that the external electrodes bridge corresponding side surfaces of adjacent ones of the at least two electricity storage elements.

According to a preferable form of the invention, the electricity-storage-element forming means comprises: (a) first moving means for continuously moving a first strip member giving one of the two protective films superposed on the respective opposite surfaces of the basic unit, in a longitudinal direction of the first strip member; (b) placing means for placing the plurality of basic units on the first strip member being continuously moved, such that one of the respective opposite surfaces of each basic unit as seen in the direction of superposition of the at least one electricity storage film and the plurality of internal electrode films is in contact with the first strip member, and such that the plurality of basic units are spaced apart from each other by a predetermined distance in the direction of movement of the first strip member; (c) second moving means for continuously moving a second strip member giving the other of the above-described two protective films in a longitudinal direction of the second strip member, such that the second strip member covers the plurality of basic units placed on the first strip member, whereby a laminar member consisting of the first and second strip members and the plurality of basic units interposed between the first and second strip members is carried by the first and second strip members in the direction of movements of the first and second strip members; and (d) cutting means for cutting the first and second strip members at positions between adjacent basic units of the laminar member, so that each of the thus cut pieces of the laminar member is obtained as each of the plurality of electricity storage elements.

According to a preferable form of the invention, the electricity-storage-element forming means further comprises pressing means for applying a pressure to the laminar member, which pressing means is disposed on an upstream side of the cutting means as seen in the direction of movements of the first and second strip members.

To achieve the above-described object, the invention also provides a film capacitor characterized in that the film capacitor is constituted by a stack of a plurality of film capacitor elements superposed on each other and two external electrodes formed on respective opposite side surfaces of the stack, wherein each of the plurality of film capacitor elements has a basic unit obtained by alternately superposing at least one dielectric film and a plurality of vapor-deposited metal films on each other, and two protective films which have an electrical insulation property and which are superposed on respective opposite surfaces of the basic unit as seen in a direction of superposition of the at least one dielectric film and the plurality of vapor-deposited metal films, and the two external electrodes are formed so as to bridge corresponding side surfaces of adjacent ones of the plurality of film capacitor elements.

According to a preferable form of the invention, gaps are formed in the respective opposite side surfaces of the stack of the plurality of film capacitor elements, such that the gaps are open outwards and parts of the vapor-deposited metal films are exposed to the outside of the stack through the gaps, and portions of the two external electrodes formed on the respective opposite side surfaces of the stack fill the gaps, and the portions of one of the two external electrodes filling the gaps formed in one of the above-described respective opposite side surfaces of the stack are defined as first connecting portions connecting the above-described one external electrode formed on the above-described one side surface of the stack to the parts of the vapor-deposited metal films exposed to the gaps, while the portions of the other external electrode filling the gaps formed in the other of the above-described respective opposite side surfaces of the stack are defined as second connecting portions connecting the above-described other external electrode formed on the above-described other side surface of the stack to the parts of the vapor-deposited metal films exposed to the gaps, wherein the above-described first connecting portions and the above-described second connecting portions are alternately arranged as seen in the direction of superposition of the plurality of film capacitor elements constituting the stack.

To achieve the above-described object, the invention also provides a process for producing a film capacitor, characterized by comprising the steps of: (a) providing a plurality of film capacitor elements each obtained by using a basic unit having a structure in which at least one dielectric film and a plurality of vapor-deposited metal films are alternately superposed on each other, and superposing two protective films having an electrical insulation property on respective opposite surfaces of the basic unit as seen in a direction of superposition of the at least one dielectric film and the plurality of vapor-deposited metal films; (b) selecting at least two film capacitor elements from the thus provided plurality of film capacitor elements; (c) superposing the selected at least two film capacitor elements on each other to form a stack of those film capacitor elements; and (d) forming two external electrodes on respective opposite side surfaces of the stack, such that the external electrodes bridge corresponding side surfaces of adjacent ones of the at least two film capacitor elements.

According to a preferable form of the invention, the step of providing the plurality of film capacitor elements comprises: continuously moving a first strip member giving one of the two protective films superposed on the respective opposite surfaces of the basic unit, in a longitudinal direction of the first strip member; placing a plurality of basic units on the first strip member being continuously moved, such that one of the respective opposite surfaces of each basic unit as seen in the direction of superposition of the at least one dielectric film and the plurality of vapor-deposited metal films is in contact with the first strip member, and such that the plurality of basic units are spaced apart from each other by a predetermined distance in the direction of movement of the first strip member; continuously moving a second strip member giving the other of the above-described two protective films in a longitudinal direction of the second strip member, such that the second strip member covers the plurality of basic units placed on the first strip member, whereby the plurality of basic units held between the first and second strip members are continuously carried by the first and second strip members; and cutting the first and second strip members at positions on respective upstream and downstream sides of each of the plurality of basic units as seen in the direction of movements of the first and second strip members, thereby successively producing the plurality of film capacitor elements.

According to a preferable form of the invention, a pressure is applied to a laminar member consisting of the first and second strip members and the plurality of basic units held between the first and second strip members while the laminar member is continuously carried, before the first and second strip members are cut.

To achieve the above-described object, the invention also provides a device for producing a film capacitor, characterized by comprising: (a) film-capacitor-element forming means for forming each of a plurality of film capacitor elements by using a basic unit obtained by alternately superposing at least one dielectric film and a plurality of vapor-deposited metal films on each other, and superposing two protective films having an electrical insulation property on respective opposite surfaces of the basic unit as seen in a direction of superposition of the at least one dielectric film and the plurality of vapor-deposited metal films; (b) stack forming means for superposing at least two of the thus formed plurality of film capacitor elements on each other, thereby forming a stack of the at least two film capacitor elements; and (c) external-electrode forming means for forming two external electrodes on respective opposite side surfaces of the stack, such that the external electrodes bridge corresponding side surfaces of adjacent ones of the at least two film capacitor elements.

According to a preferable form of the invention, the film-capacitor-element forming means comprises: (a) first moving means for continuously moving a first strip member giving one of the two protective films superposed on the respective opposite surfaces of the basic unit, in a longitudinal direction of the first strip member; (b) placing means for placing the plurality of basic units on the first strip member being continuously moved, such that one of the respective opposite surfaces of each basic unit as seen in the direction of superposition of the at least one dielectric film and the plurality of vapor-deposited metal films is in contact with the first strip member, and such that the plurality of basic units are spaced apart from each other by a predetermined distance in the direction of movement of the first strip member; (c) second moving means for continuously moving a second strip member giving the other of the above-described two protective films, such that the second strip member covers the plurality of basic units placed on the first strip member, whereby a laminar member consisting of the first and second strip members and the plurality of basic units interposed between the first and second strip members is carried by the first and second strip members in the direction of movements of the first and second strip members; and (d) cutting means for cutting the first and second strip members at positions between adjacent basic units of the laminar member, so that each of the thus cut pieces of the laminar member is obtained as each of the plurality of film capacitor elements.

According to a preferable form of the invention, the film-capacitor-element forming means further comprises pressing means for applying a pressure to the laminar member, which pressing means is disposed on an upstream side of the cutting means as seen in the direction of movements of the first and second strip members.

Namely, the capacitance of the electricity storage device according to the invention can be increased by increasing the number of the electricity storage elements superposed on each other, without increasing the numbers of the at least one electricity storage film and the internal electrode films of each of the plurality of electricity storage elements. Therefore, the capacitance of the electricity storage device can be increased or decreased by using the electricity storage elements having the same numbers of the at least one electricity storage film and the internal electrode films, and adjusting the number of the electricity storage elements superposed on each other.

Where the plurality of electricity storage elements have the same numbers of the at least one electricity storage film and the internal electrode films, the plurality of electricity storage elements can be produced by using a single device for forming the electricity storage element having a structure similar to that of the above-described device for producing the film capacitor element, without a need to change setting of the device regarding the numbers of superposition of the at least one electricity storage film and the internal electrode films, and without a need to change the structure of the device, and without a need to change operating conditions of the device, irrespective of the required capacitance of the electricity storage device to be obtained. Accordingly, efficiency of production of the plurality of electricity storage elements and the electricity storage device can be effectively improved.

The electricity storage device according to the invention is configured so as to be able to immediately meet a demand for an increase of its capacitance, by merely increasing the number of the electricity storage elements constituting the stack. Therefore, even where there arises a need for a new electricity storage device having a high capacitance value, such electricity storage device can be produced by using the existing equipment without employing new production equipment.

Unlike the conventional electricity storage device having a single electricity storage element, the electricity storage device according to the invention has the plurality of electricity storage elements superposed on each other. Accordingly, in the electricity storage device of the invention, the two protective films superposed on each other are disposed between the adjacent (mutually superposed) electricity storage elements at intermediate positions of the electricity storage device as seen in the direction of its thickness, in addition to the protective films providing the respective opposite surfaces of the electricity storage device as seen in the direction of superposition of the electricity storage elements. Therefore, when insulation breakdown takes place within one of the plurality of electricity storage elements of the electricity storage device, and progresses in the direction of its thickness, the progress of the insulation breakdown is stopped by the two protective films superposed on each other and disposed between the above-described one electricity storage element and another electricity storage element adjacent to the above-described one electricity storage element.

Thus, the electricity storage device according to the invention not only extremely advantageously permits more efficient production of plural kinds of electricity storage device having respective different capacitance values, without the need to change production equipment and the need to employ new production equipment, but also advantageously prevents the progress of the insulation breakdown in the direction of its thickness.

The process for producing the electricity storage device according to the invention not only permits production of the electricity storage device which can effectively prevent the progress of the insulation breakdown in the direction of its thickness, but also permits more efficient and easy production of the plural kinds of electricity storage device having respective different capacitance values, without the need to change the production equipment and the need to employ new production equipment.

By using the device for producing the electricity storage device according to the invention, substantially the same operational and physical advantages as those achieved by the process for producing the electricity storage device according to the invention can be achieved.

The film capacitor according to the invention not only extremely advantageously permits more efficient production of plural kinds of film capacitor having respective different capacitance values, without the need to change the production equipment and the need to employ new production equipment, but also effectively prevents the progress of the insulation breakdown in the direction of its thickness.

The process for producing the film capacitor according to the invention not only permits production of the film capacitor which can effectively prevent the progress of the insulation breakdown in the direction of its thickness, but also permits more efficient and easy production of the plural kinds of film capacitor having respective different capacitance values, without the need to change the production equipment and the need to employ new production equipment.

By using the device for producing the film capacitor according to the invention, substantially the same operational and physical advantages as those achieved by the process for producing the film capacitor according to the invention can be achieved.

### BRIEF DESCRIPTION OF THE DRAWINGS

FIG. 1 is a schematic cross sectional view showing a film capacitor as an electricity storage device having a structure according to one embodiment of the invention;

FIG. 2 is a schematic view showing an example of a step implemented in production of the film capacitor of FIG. 1, wherein a capacitor element preform is formed;

FIG. 3 is a schematic view showing an example of a step implemented following the step of FIG. 2, wherein the film capacitor element is cut out from the capacitor element preform;

FIG. 4 is a schematic view showing an example of a step implemented following the step of FIG. 3, wherein a plurality of film capacitor elements are superposed on each other to form a stack;

FIG. 5 is a schematic view showing an example of a step implemented following the step of FIG. 4, wherein an external electrode is formed on a side surface of the stack of the film capacitor elements;

FIG. 6 is a schematic view corresponding to that of FIG. 4 and showing an example of a step implemented in production of a film capacitor having a structure according to another embodiment of the invention;

FIG. 7 is a schematic view corresponding to that of FIG. 5 and showing an example of a step implemented following the step of FIG. 6;

FIG. 8 is a schematic view showing an example of a device used to produce the film capacitor of FIG. 1;

FIG. 9 is a schematic cross sectional view showing an all-solid lithium-ion secondary battery as an electricity storage device having a structure according to a further embodiment of the invention;

FIG. 10 is a schematic cross sectional view showing a cell element of the all-solid lithium-ion secondary battery of FIG. 9;

FIG. 11 is a schematic cross sectional view showing a laminar film which consists of a metallic foil and resin films, and which is used to produce the cell element of FIG. 10;

FIG. 12 is a schematic cross sectional view showing another laminar film which is used to produce the cell element of FIG. 10, and which consists of a metallic foil and resin films, and which has a structure different from that of the laminar film of FIG. 11; and

FIG. 13 is a schematic cross sectional view showing a further laminar film which is used to produce the cell element of FIG. 10, and which consists of a metallic foil and resin films, and which has a structure different from those of the laminar films of FIGS. 11 and 12.

### DETAILED DESCRIPTION OF THE INVENTION

To clarify the invention more specifically, embodiments of the invention will be described by reference to the drawings.

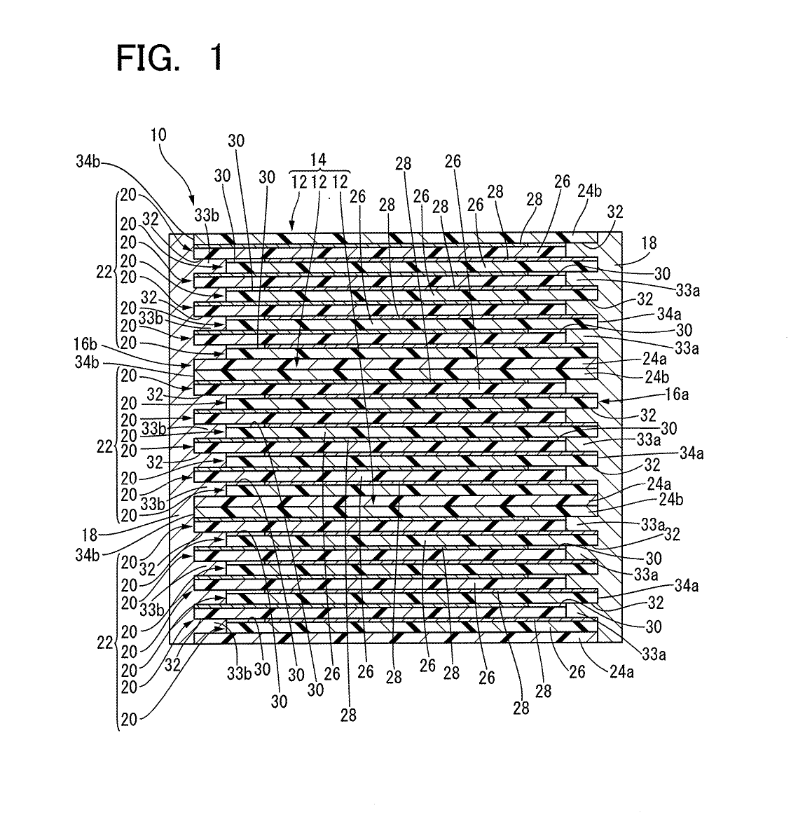

Referring first to the longitudinal cross sectional view of FIG. 1, there is shown a film capacitor 10 as an electricity storage device having a structure according to one embodiment of the invention. As is apparent from FIG. 1, the film capacitor 10 of this embodiment has three film capacitor elements 12 as electricity storage elements, and is constituted by a stack 14 of the three film capacitor elements 12 superposed on each other, and external electrodes 18 formed on respective two side surfaces 16a and 16b of the stack 14, which side surfaces 16a and 16b are opposite to each other in a direction perpendicular to the direction of superposition of the film capacitor elements 12.

Described more specifically, the film capacitor elements 12 of the film capacitor 10 of this embodiment have the same structure in which a plurality of metallized films 20 are superposed on each other to form a basic unit 22, and a first protective film 24a is superposed on one of opposite surfaces of the basic unit 22 as seen in the direction of its thickness (direction of superposition of the metallized films 20), while a second protective film 24b is superposed on the other of the opposite surfaces of the basic unit 22. In this embodiment, each film capacitor element 12 (basic unit 22) has 8 metallized films 20. In this respect, it is noted that the number of the metallized films 20 of each film capacitor element 12 (basic unit 22) is not limited to that described above.

Each of the metallized films 20 of the film capacitor element 12 is constituted by a resin film 26 as an electricity storage film and a vapor-deposited metal film 28 which is formed on one of opposite major surfaces of the resin film 26 and which serves as an internal electrode film. In one end portion of the metallized film 20 as seen in the direction of its width (right to left direction as seen in FIG. 1), there is a margin portion 30 in which the vapor-deposited metal film 28 is not formed on the resin film 26. It is to be understood that in FIG. 1, the resin films 26 and the vapor-deposited metal films 28 of the metallized films 20, the first and second protective films 24a and 24b, and the external electrodes 18 are shown with exaggeratedly large thicknesses, and the number of the metallized films 20 of each film capacitor element 12 shown in FIG. 1 is extremely smaller than the actual number, for easy understanding of the structures of the film capacitor 10 and the film capacitor elements 12.

The resin film 26 of each metallized film 20 is a bi-axially stretched film formed of polypropylene or polyethylene terephthalate, for example. The vapor-deposited metal film 28 is formed of aluminum or zinc, for example, on the resin film 26 by a conventional vapor-deposition process. It is possible to form, as the internal electrode film, a thin metallic film on the resin film 26 by a PVD process other than the vapor-deposition process, such as sputtering, or by a conventional CVD process, in place of the vapor-deposited metal film 28. Although the material of the first and second protective films 24a and 24b is not particularly limited, as long as the material has a high electric insulation property, resin films formed of the same resin material as the resin film 26 of the metallized film 20 are generally used as the first and second protective films 24a and 24b.

The plurality of metallized films 20 are superposed on each other on the first protective film 24a, such that the resin films 26 and the vapor-deposited metal films 28 are alternately arranged, and such that the margin portions 30 of the adjacent two metallized films 20 are disposed on the respective opposite sides as seen in the direction of their width. The second protective film 24b is superposed on the vapor-deposited metal film 28 of the uppermost one of the plurality of metallized films 20 superposed on each other. Thus, the film capacitor element 12 has a laminar structure in which the first and second protective films 24a and 24b are superposed on the respective lower and upper surfaces of the basic unit 22 consisting of the plurality of metallized films 20.

In the film capacitor element 12, the adjacent two metallized films 20 are superposed on each other such that an end portion of one of the adjacent two metallized films 20 laterally projects from the end face of the other metallized film 20 on the side of its margin portion 30. Accordingly, side surfaces of the film capacitor element 12 (basic unit 22 consisting of the plurality of metallized films 20) which are opposite to each other in the direction of the width of the film capacitor element 12 (right to left direction as seen in FIG. 1) have gaps 32 which are laterally open in those side surfaces. Each gap 32 is formed between widthwise end portions of the two metallized films 20 disposed on the respective opposite sides of another metallized film 20. The upper one of the adjacent two metallized films 20 defining each gap 32 is not superposed on an end portion of the vapor-deposited metal film 28 of the lower one of the adjacent two metallized films 20, so that the above-described end portion of the vapor-deposited metal film 28 of the lower metallized film 20 is exposed to the outside of the film capacitor element 12 through the gap 32.

The above-described stack 14 is formed by superposing the three film capacitor elements 12 on each other in the direction of superposition of the metallized films 20. In the stack 14, the first protective film 24a superposed on the lower surface of the basic unit 22 of one of the film capacitor elements 12 is superposed on the second protective film 24b superposed on the upper surface of the basic unit 22 of another film capacitor element 12.

Thus, in the stack 14 of this embodiment, a total of 24 metallized films 20 are superposed on each other between the first and second protective films 24a and 24b constituting the respective lowermost and uppermost layers of the stack 14, and the two protective films 24a and 24b superposed on each other are interposed between the 8^{th} and 9^{th} metallized films 20 and between the 16^{th} and 17^{th} metallized films 20 as counted from the bottom of the stack 14. Namely, the first and second protective films 24a and 24b superposed on each other are disposed at intermediate positions of the stack 14 as seen in the direction of its thickness, such that the two protective films 24a and 24b are interposed between every 8 metallized films 20 among the 24 metallized films 20 superposed on each other.

The external electrodes 18 are formed by thermal spraying on the side surfaces 16a and 16b of the stack 14 of the three film capacitor elements 12, which side surfaces 16a and 16b are opposite to each other in the direction of the width of the stack 14 (right to left direction as seen in FIG. 1), and which side surfaces 16a and 16b have the above-described gaps 32 formed therein.

In this embodiment, one of the two external electrodes 18 which is formed on one of the widthwise opposite side surfaces of the stack 14 (on the side surface 16a) bridges side surfaces 34a of the adjacent film capacitor elements 12, while the other external electrode 18 formed on the other of the widthwise opposite side surfaces of the stack 14 (on the side surface 16b) bridges side surfaces 34b of the adjacent film capacitor elements 12, which side surfaces 34a and 34b are opposite to each other in the direction of the width of the film capacitor elements 12. Namely, the above-described one external electrode 18 is formed as a one-piece body covering the entirety of the side surface 16a of the stack 14, while the above-described other external electrode 18 is formed as a one-piece body covering the entirety of the other side surface 16b of the stack 14.

Further, the pair of external electrodes 18 fill the gaps 32 which are laterally open in the widthwise opposite side surfaces 34a and 34b of the film capacitor elements 12, and are bonded to the above-described end portions of the vapor-deposited metal films 28 exposed to those gaps 32. Portions of the external electrode 18 filling the gaps 32 in the side surfaces 34a are defined as first connecting portions 33a, while portions of the other external electrode 18 filling the gaps 32 in the side surfaces 34b are defined as second connecting portions 33b. The plurality of first connecting portions 33a (12 first connecting portions 33a in this embodiment) and the plurality of second connecting portions 33b (12 second connecting portions 33b in this embodiment) are respectively formed in the side surfaces 34a and 34b, such that the first and second connecting portions 33a and 33b are alternately arranged as seen in the direction of superposition of the resin films 26 and the vapor-deposited metal films 28. The material of the pair of external electrodes 18 is not particularly limited, and conventionally used materials such as zinc and aluminum are adequately used to form the external electrodes 18.

Thus, the film capacitor 10 is formed such that the pair of external electrodes 18 cover the entireties of the respective widthwise opposite side surfaces 16a and 16b of the stack 14 of the film capacitor elements 12, and such that the external electrodes 18 are surely connected to the end portions of the vapor-deposited metal films 28 of the metallized films 20 at the first and second connecting portions 33a and 33b.

Namely, unlike the conventional film capacitor assembly formed by superposing on each other a plurality of film capacitors each having a single film capacitor element and external electrodes formed on two opposite side surfaces of the film capacitor element, the film capacitor 10 of this embodiment has an independent structure in which the external electrodes 18 are formed as the one-piece bodies on the respective opposite side surfaces 16a and 16b of the stack 14 of the plurality of film capacitor elements 12 superposed on each other. Terminals or the like not shown are connected to the two external electrodes 18 of the film capacitor 10, as necessary.

The film capacitor 10 constructed as described above is advantageously produced by steps described below.

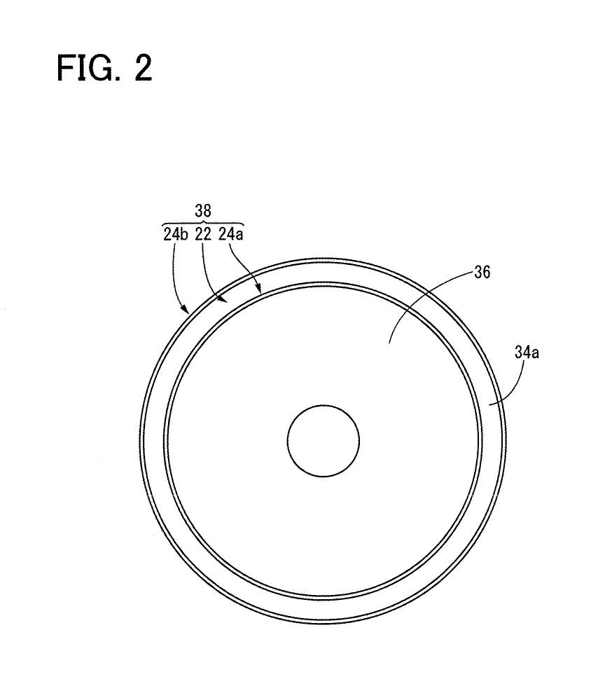

Initially, as shown in FIG. 2, the first protective film 24a is wound by one turn on the entire circumference of a rotary drum 36 of a film-capacitor-element production device. Then, in this embodiment, the metallized films 20 are wound by 8 turns on the first protective film 24a, such that the adjacent two metallized films 20 are offset with respect to each other by a predetermined amount in the direction of their width, and such that the margin portions 30 of the adjacent two metallized films 20 are disposed on the respective opposite sides as seen in the direction of their width. Then, the second protective film 24b is wound by one turn on the entire circumference of the uppermost (outermost) one of the 8 metallized films 20 wound on the first protective film 24a. In this respect, it is noted that the metallized films 20 are not shown in FIG. 2 and FIGS. 3-7 which will be referred to later.

Thus, a capacitor element preform 38 is formed on the circumferential surface of the rotary drum 36. The capacitor element preform 38 is constituted by: the basic unit 22 consisting of the 8 metallized films 20 superposed on each other; the first protective film 24a superposed on one of two surfaces of the basic unit 22 which surfaces are opposite to each other in the direction of the thickness of the basic unit 22; and the second protective film 24b superposed on the other of the above-described two surfaces of the basic unit 22. The capacitor element preform 38 takes the form of a ring held in contact with the circumferential surface of the rotary drum 36. Although not shown in FIG. 2, the margin portions 30 of the metallized films 20 are disposed on the sides of the widthwise opposite side surfaces 34a and 34b of the capacitor element preform 38, and the plurality of gaps 32 are formed in each of those side surfaces 34a and 34b.

Then, although not illustrated in the drawings, the capacitor element preform 38 is removed from the rotary drum 36, and stretched into the form of a flat sheet. A heat aging treatment is performed by a conventional process with respect to the capacitor element preform 38 as necessary, to increase adhesiveness between the first and second protective films 24a, 24b and the basic unit 22 of the capacitor element preform 38, and adhesiveness between the metallized films 20 of the basic unit 22.

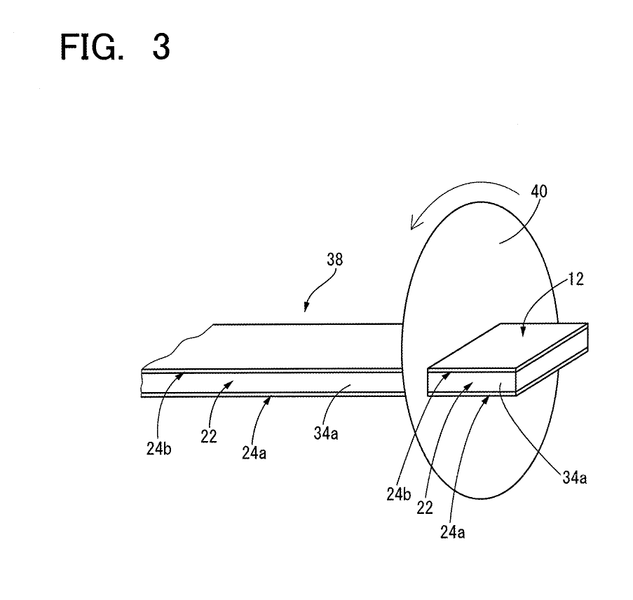

Then, the capacitor element preform 38 stretched into the form of the flat sheet is cut in its width direction into a plurality of pieces having the same length by using a cutting blade 40, as shown in FIG. 3, whereby the plurality of film capacitor elements 12 having the same width and the same length are obtained. Although not shown in FIG. 3, in the thus obtained plurality of film capacitor elements 12, the plurality of gaps 32 are formed in the two side surfaces 34a and 34b (only the side surface 34a is shown in FIG. 3) adjacent to the surfaces along which the film capacitor elements 12 are cut out from the capacitor element preform 38 by using the cutting blade 40.

From the thus obtained plurality of film capacitor elements 12 having the same size, at least two film capacitor elements 12 are selected. In this specific example, three film capacitor elements 12 are selected.

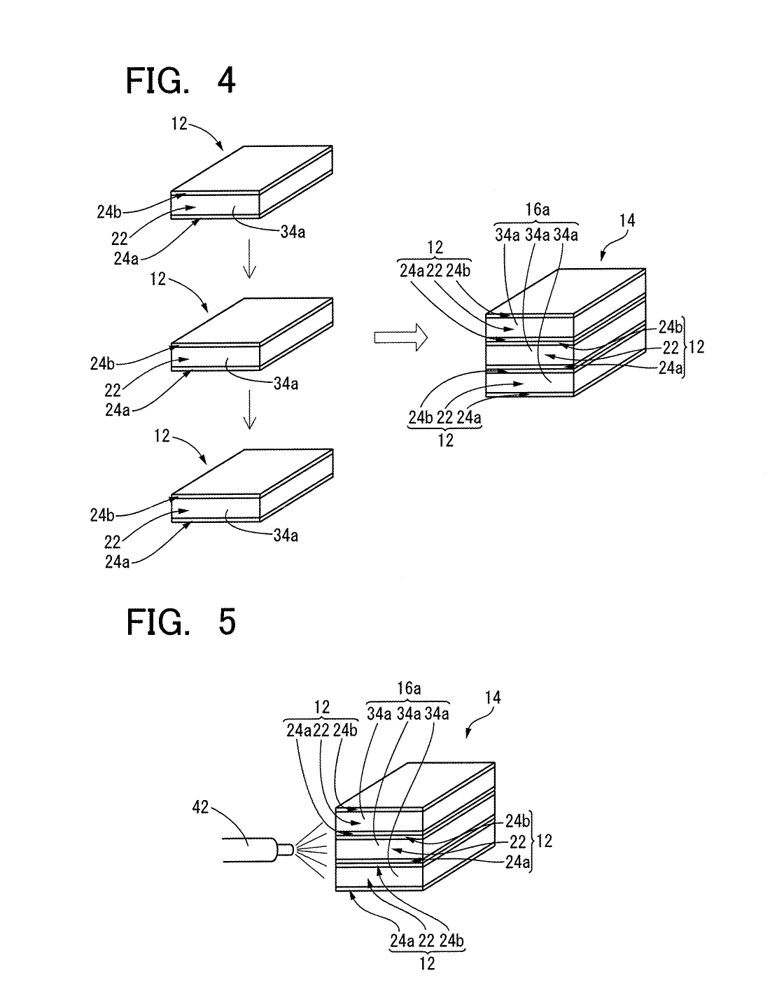

The three film capacitor elements 12 are superposed on each other as shown in FIG. 4. At this time, the first protective film 24a superposed on the lower surface of the basic unit 22 of one of the film capacitor elements 12 is superposed on the second protective film 24b superposed on the upper surface of the basic unit 22 of another film capacitor element 12, such that the entirety of a surface of the above-described first protective film 24a remote from the basic unit 22 is held in close contact with the entirety of a surface of the above-described second protective film 24b remote from the basic unit 22. Further, the three film capacitor elements 12 are superposed on each other such that their two side surfaces 34a and 34b (only the side surfaces 34a are shown in FIG. 4) having the gaps 32 are positioned on the respective two sides.

Thus, the stack 14 of the three film capacitor elements 12 is obtained. In the thus obtained stack 14, a total of 24 metallized films 20 are superposed on each other between the first and second protective films 24a and 24b constituting the respective lowermost and uppermost layers of the stack 14, and the two protective films 24a and 24b superposed on each other are interposed between every 8 metallized films 20 (see FIG. 1). Although not shown in FIG. 4, the plurality of gaps 32 are formed in each of the two side surfaces 16a and 16b (only the side surface 16a is shown in FIG. 4) of the stack 14.

Subsequently, as shown in FIG. 5, a thermal-spraying material such as zinc or aluminum in a molten state is sprayed from a thermal-spraying nozzle 42 of an external-electrode forming device not shown, onto the two side surfaces 16a and 16b (only the side surface 16a is shown in FIG. 5) of the stack 14, in which side surfaces 16a and 16b the above-described plurality of gaps 32 are formed, whereby the external electrodes 18 are formed on the two side surfaces 16a and 16b of the stack 14 of the three film capacitor elements 12.

At this time, the thermal-spraying material in the molten state is sprayed onto the entireties of the two side surfaces 16a and 16b of the stack 14, so that the entireties of the two side surfaces 16a and 16b are covered by the external electrodes 18. Thus, one of the external electrodes 18 is formed as the one-piece body bridging the side surfaces 34a of the adjacent film capacitor elements 12 and covering the entirety of the side surface 16a of the stack 14, while the other external electrode 18 is formed as the one-piece body bridging the side surfaces 34b of the adjacent film capacitor elements 12 and covering the entirety of the side surface 16b of the stack 14. Further, portions of the external electrodes 18 fill the plurality of gaps 32 formed in the two side surfaces 16a and 16b of the stack 14, whereby the above-described first and second connecting portions 33a and 33b are formed.

Thus, the film capacitor 10 having the independent structure shown in FIG. 1 is obtained. In the film capacitor 10, the 24 metallized films 20 are superposed on each other, and the external electrodes 18 are formed as the one-piece bodies on the respective two side surfaces 16a and 16b of the film capacitor 10. The film capacitor 10 can secure a stable electric conductivity.

According to this embodiment, it is possible to easily produce a film capacitor 10 with a larger number of the metallized films 20 superposed on each other and a higher capacitance than the film capacitor 10 shown in FIG. 1 having the 24 metallized films 20 superposed on each other, or with a smaller number of the metallized films 20 superposed on each other and a lower capacitance than the film capacitor 10 of FIG. 1.

For instance, to produce the film capacitor 10 which has 40 metallized films 20 superposed on each other and a higher capacitance, five film capacitor elements 12 are selected from the plurality of film capacitor elements 12 formed by the step of forming the capacitor element preform 38 as shown in FIG. 2 and the step of cutting the capacitor element preform 38 as shown in FIG. 3.

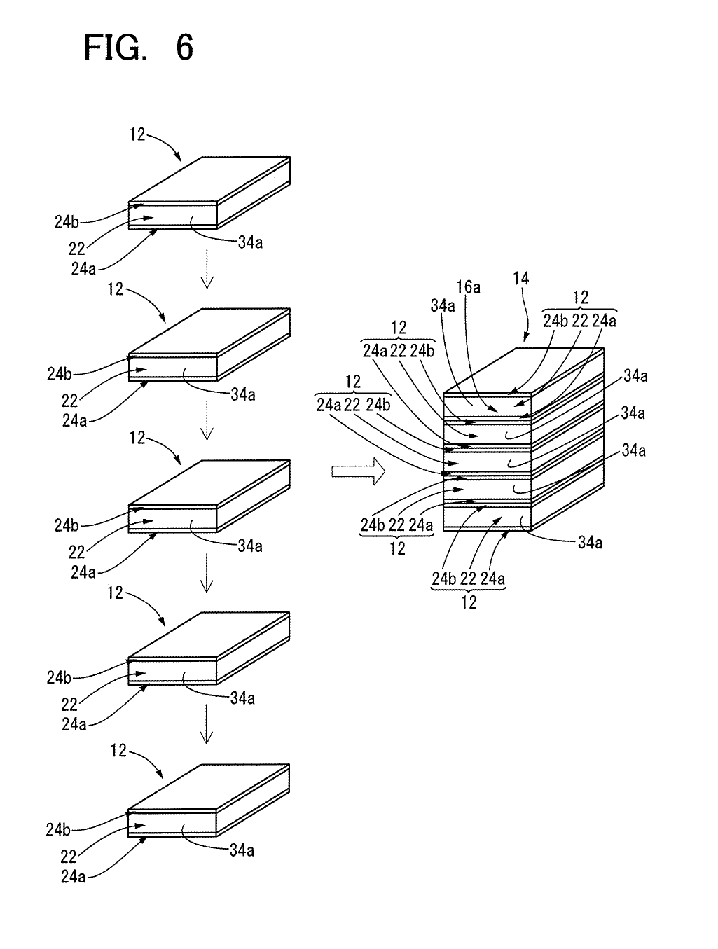

Then, the five film capacitor elements 12 are superposed on each other to form the stack 14 of the five film capacitor elements 12, as shown in FIG. 6. At this time, the five film capacitor elements 12 are superposed on each other, such that the first and second protective films 24a and 24b of the adjacent film capacitor elements 12 are superposed on each other, and such that the two side surfaces 34a and 34b of the film capacitor elements 12 having the gaps 32 are positioned on the respective two sides, as in the case where the three film capacitor elements 12 are superposed on each other to form the stack 14 in the production of the film capacitor 10 shown in FIG. 1.

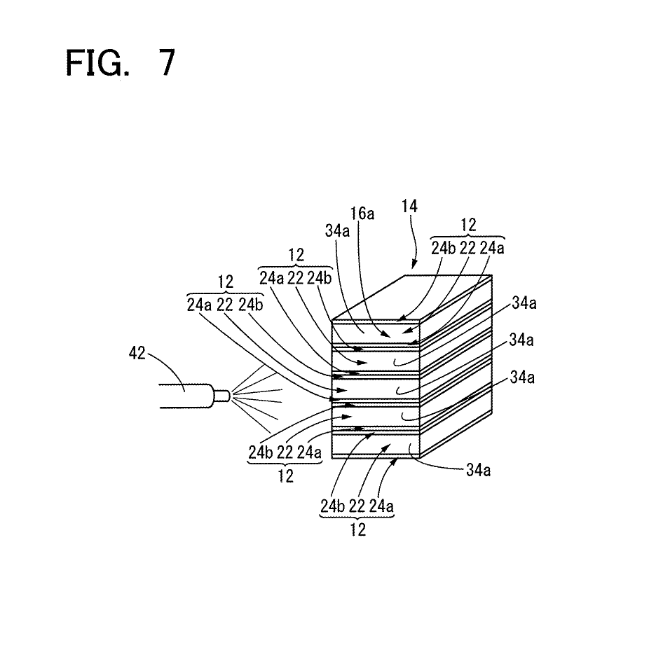

Then, as shown in FIG. 7, the thermal-spraying material such as zinc or aluminum in the molten state is sprayed from the thermal-spraying nozzle 42, onto the entireties of the two side surfaces 16a and 16b (only the side surface 16a is shown in FIG. 7) of the stack 14, in which the plurality of gaps 32 are formed, whereby the external electrodes 18 are formed on the two side surfaces 16a and 16b of the stack 14 of the five film capacitor elements 12, such that the external electrodes 18 bridge the corresponding side surfaces 34a and 34b of the adjacent film capacitors 12, and cover the entireties of the two side surfaces 16a and 16b of the stack 14. Further, the first and second connecting portions 33a and 33b are formed by the external electrodes 18 filling the gaps 32 which are laterally open in the widthwise opposite side surfaces 34a and 34b of the film capacitor elements 12. Thus, the film capacitor 10 having the 40 metallized films 20 superposed on each other and the higher capacitance is obtained. The thus obtained film capacitor 10 has a stable electric conductivity.

On the other hand, to produce the film capacitor 10 which has 16 metallized films 20 superposed on each other and a lower capacitance, two film capacitor elements 12 are selected from the plurality of film capacitor elements 12 formed by the step of forming the capacitor element preform 38 as shown in FIG. 2 and the step of cutting the capacitor element preform 38 as shown in FIG. 3.

Then, the two film capacitor elements 12 are superposed on each other to form the stack 14 of the two film capacitor elements 12. At this time, the two film capacitor elements 12 are superposed on each other, as in the case where the three film capacitor elements 12 are superposed on each other to form the stack 14 in the production of the film capacitor 10 shown in FIG. 1.

Then, as in the production of the film capacitor 10 shown in FIG. 1, the thermal-spraying material such as zinc or aluminum in the molten state is sprayed from the thermal-spraying nozzle 42, onto the entireties of the two side surfaces 16a and 16b of the stack 14, in which the plurality of gaps 32 are formed, whereby the external electrodes 18 are formed on the two side surfaces 16a and 16b of the stack 14 of the two film capacitor elements 12, such that the external electrodes 18 bridge the corresponding side surfaces 34a and 34b of the two film capacitors 12, and cover the entireties of the two side surfaces 16a and 16b of the stack 14. Further, the first and second connecting portions 33a and 33b are formed, whereby the film capacitor 10 having the 16 metallized films 20 superposed on each other and the lower capacitance is obtained.

It will be understood from the foregoing description that the capacitance of the film capacitor 10 of this embodiment can be controlled by merely increasing or reducing the number of the film capacitor elements 12 selected to form the stack 14 from the plurality of film capacitor elements 12 produced beforehand, with the same number of the metallized films 20, namely, without changing the number of the metallized films 20 constituting each of the film capacitor elements 12.

Owing to the structure of the film capacitor 10 of this embodiment, in production of plural kinds of film capacitor 10 having respective different capacitance values, the film capacitor elements 12 to be used for producing the plural kinds of film capacitor 10 can be easily produced by winding the first and second protective films 24a and 24b and the plurality of metallized films 20 on the rotary drum 36 of the film-capacitor-element production device, without changing a setting regarding the number of winding (superposition) of the metallized films 20 on the rotary drum 36, and operating conditions of the film-capacitor-element production device, let alone the structure of the film-capacitor-element production device, so that efficiency of the production of the film capacitor elements 12 and the film capacitors 10 can be extremely effectively improved.

Where the above-described structure of the film capacitor 10 is employed, the film capacitor 10 having a higher capacitance can be easily produced at a low cost by merely increasing the number of the film capacitor elements 12 constituting the stack 14 of the film capacitor 10, without employing new production equipment configured to produce the film capacitor 10.

Further, the structure of the film capacitor 10 of this embodiment advantageously eliminates a need to store a number of film capacitors 10 having respective different capacitance values, as stocks, since the film capacitor 10 having a desired capacitance can be produced by using the required number of the film capacitor elements 12, which are selected from a number of film capacitor elements 12 which have been produced beforehand with the same number of the metallized films 20.

Additionally, in the film capacitor 10 of this embodiment, the two protective films 24a and 24b superposed on each other are disposed at intermediate positions of the film capacitor 10 as seen in the direction of its thickness, such that the two protective films 24a and 24b are interposed between every 8 metallized films 20 of the 24 metallized films 20 superposed on each other. Accordingly, when insulation breakdown takes place in any one of the 24 metallized films 20, and progresses successively through the mutually superposed metallized films 20 in the direction of the thickness of the film capacitor 10, the insulation breakdown of the metallized films 20 is stopped by the two protective films 24a and 24b superposed on each other and having a sufficiently large thickness as a whole, whereby excellent durability of the film capacitor 10 can be effectively secured.

The process for obtaining the plurality of film capacitor elements 12 is not limited to that described above. Various processes can be employed to obtain the plurality of film capacitor elements 12.

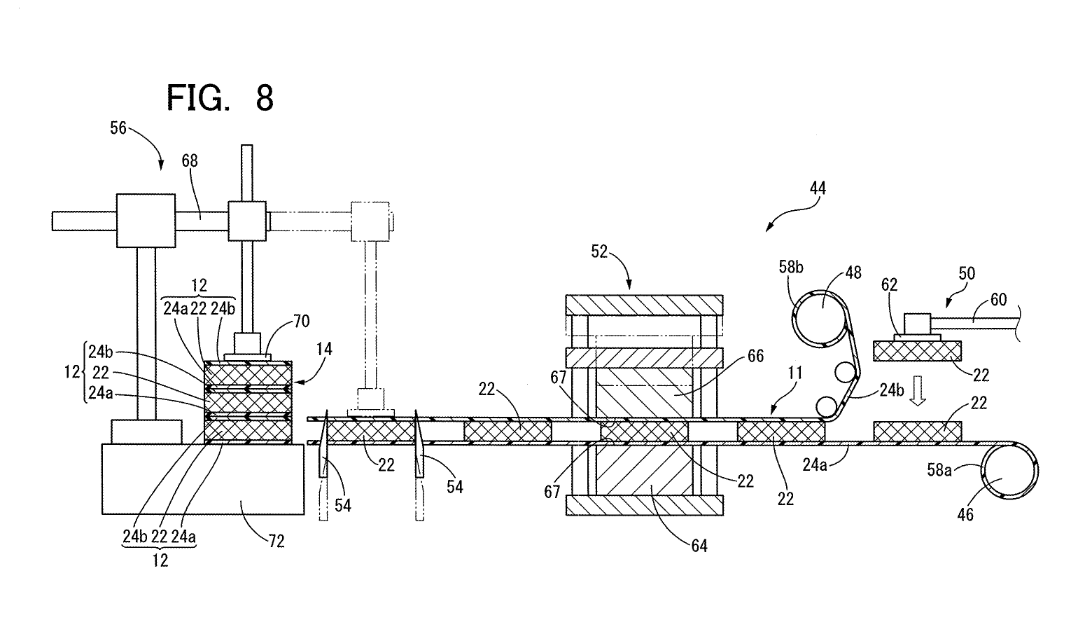

FIG. 8 shows an example of a production device (electricity-storage-element forming means) suitably used to produce the plurality of film capacitor elements 12 by a process other than the above-described process. As is apparent from FIG. 8, the production device 44 has a first feeding roller 46 (first moving means), a second feeding roller 48 (second moving means), a basic-unit transferring device 50 (placing means), a pressing device 52 (pressing means) and two cutting blades 54 (cutting means).

Described more specifically, the first feeding roller 46 is configured to be rotated by an electric motor or other rotating device not shown. A first roll 58a of a first strip member in the form of an elongate strip of the first protective film 24a is installed on the first feeding roller 46. By rotation of the first feeding roller 46, the first protective film 24a is continuously unwound from the first roll 58a installed on the first feeding roller 46, and continuously moved in its longitudinal direction.

The basic-unit transferring device 50 has a movable arm 60. A sucking pad 62 which exerts a suction force by an operation of a sucking device not shown is attached to the distal end of the movable arm 60. The basic-unit transferring device 50 is configured to successively transfer a plurality of basic units 22 formed beforehand onto the first protective film 24a moving in one direction, by operations of the sucking pad 62 and the movable arm 60, so that the plurality of basic units 22 are placed on the first protective film 24a at its upstream end as seen in the direction of its movement. In this respect, it is noted that the specific structure of the basic-unit transferring device 50 is not particularly limited, as long as the basic-unit transferring device 50 can successively transfer the basic units 22 onto the first protective film 24a moving in the one direction. For instance, the sucking pad 62 may be replaced with structural means for holding the basic units 22 to place the basic units 22 on the first protective film 24a.

On the other hand, the second feeding roller 48 is disposed diagonally upwardly of the first feeding roller 46 on the fore side as seen in the direction of movement of the first protective film 24a. The second feeding roller 48 is configured to be rotated by an operation of an electric motor or other rotating device not shown, in a direction opposite to the direction of rotation of the first feeding roller 46, at the same rotating speed as the first feeding roller 46. A second roll 58b of a second strip member in the form of an elongate strip of the second protective film 24b is installed on the second feeding roller 48.

By rotation of the second feeding roller 48, the second protective film 24b is continuously unwound from the second roll 58b installed on the second feeding roller 48, and continuously moved in its longitudinal direction, so that the second protective film 24b is moved above the first protective film 24a with a predetermined distance therebetween, in the same direction as the first protective film 24a. The second protective film 24b moving in the same direction as the first protective film 24a is superposed on the basic units 22 successively placed onto the first protective film 24a by the basic-unit transferring device 50, so that the basic units 22 are held between the first and second protective films 24a and 24b. Thus, the plurality of basic units 22 are interposed and held between the elongate first and second protective films 24a and 24b to form a laminar member 11 consisting of the first and second protective films 24a and 24b and the basic units 22, and the basic units 22 are successively carried in the direction of movement of the first and second protective films 24a and 24b along with their movements.

The pressing device 52 has a lower pressing plate 64 fixed in position and an upper pressing plate 66 which is disposed above and in opposition to the lower pressing plate 64 with a predetermined distance therebetween. Mutually opposed surfaces of the lower pressing plate 64 and the upper pressing plate 66 serve as flat pressing surfaces 67. The upper pressing plate 66 is configured so as to be movable in the vertical direction by an operation of a hydraulic cylinder or other moving device not shown. The pressing device 52 is located in the path of movement of the laminar member 11 described above, such that the upper and lower pressing plates 66 and 64 are disposed respectively above and below the laminar member 11. While the laminar member 11 is moved by rotations of the first and second feeding rollers 46 and 48, when portions of the laminar member 11, in which the basic units 22 are interposed between the first and second protective films 24a and 24b, namely, the portions of the laminar member 11 including the basic units 22, reach a position between the upper and lower pressing plates 66 and 64, the upper pressing plate 66 is moved downwards. Thus, the pressing device 52 is configured to apply a pressure to the portions of the laminar member 11 including the basic units 22, in the path of movement of the laminar member 11.

The two cutting blades 54 are disposed below the first protective film 24a on the downstream side of the pressing device 52 as seen in the direction of movement of the laminar member 11. The two cutting blades 54 are spaced apart from each other by a distance which is substantially the same as or slightly larger than the length of the basic unit 22 (dimension of the basic unit 22 in the direction of movement of the laminar member 11). The two cutting blades 54 are configured so as to be movable in the vertical direction by an operation of a known actuator. By upwardly moving the two cutting blades 54 from positions below the first protective film 24a, the first and second protective films 24a and 24b of the laminar member 11 moving in the above-indicated one direction are cut between the adjacent basic units 22. More specifically described, the first and second protective films 24a and 24b are simultaneously cut at two positions on the respective upstream and downstream sides of each basic unit 22 as seen in the direction of movements of the first and second protective films 24a and 24b, such that the cut pieces of the first and second protective films 24a and 24b have the same length as the basic unit 22. In this respect, it is noted that the cutting blades 54 may be rotary cutting blades.

A laminating device 56 (stack forming means) is provided laterally adjacent to the production device 44 of the film capacitor element 12. Like the basic-unit transferring device 50, the laminating device 56 has a movable arm 68 and a sucking pad 70 attached to the distal end of the movable arm 68. The movable arm 68 is configured to move the sucking pad 70 in the vertical direction and in the direction of movement of the laminar member 11 (direction of movements of the first and second protective films 24a and 24b), by an operation of a known actuator not shown. The sucking pad 70 is configured to exert a suction force by an operation of a sucking device not shown. Further, the laminating device 56 is fixedly mounted on a suitable table 72. It is noted that the structure of the laminating device 56 is also not particularly limited. For instance, the sucking pad 70 may be replaced with structural means for holding each of the plurality of film capacitor elements 12 described later, to superpose the film capacitor elements 12 on each other.

The film capacitor elements 12 are produced by using the thus constructed production device 44, and the film capacitor 10 is obtained by using the produced film capacitor elements 12, as described below.

Initially, the first feeding roller 46 is continuously rotated, so that the first protective film 24a is unwound from the first roll 58a, and continuously moved in its longitudinal direction.

Then, the plurality of basic units 22 formed beforehand are transferred one after another from a place where they are stored, by the basic-unit transferring device 50, and placed on the first protective film 24a continuously moving in the above-indicated one direction, such that the lower surfaces of the basic units 22 are in contact with the first protective film 24a, and such that the basic units 22 are spaced apart from each other with a constant distance therebetween in the direction of movement of the first protective film 24a, and such that the side surfaces 34a and 34b of the basic units 22 on which the external electrodes 18 are to be formed are opposite to each other in a direction perpendicular to the direction of movement of the first protective film 24a.

While the basic units 22 are superposed on the first protective film 24a, the second feeding roller 48 is continuously rotated, so that the second protective film 24b is unwound from the second roll 58b, superposed on the basic units 22 superposed on the first protective film 24a, and continuously moved in the same direction as the first protective film 24a. Thus, the plurality of basic units 22 are held between the first and protective films 24a and 24b which are superposed on the respective lower and upper surfaces of the plurality of basic units 22, whereby the laminar member 11 is formed and continuously moved toward the pressing device 52.

Then, in the course of movement of the laminar member 11, a pressure is applied to the portions of the laminar member 11 including the basic units 22, by the pressing device 52. Thus, each of the above-described portions of the laminar member 11 is successively pressed between the flat pressing surfaces 67 of the upper and lower pressing plates 66 and 64 of the pressing device 52, into the form of a flat sheet.

As each portion of the laminar member 11 including the basic unit 22 in the form of the flat sheet is moved to the position between the two cutting blades 54, the two cutting blades 54 are moved upwards, so that the first and second protective films 24a and 24b are cut on the opposite sides of the portion of the laminar member 11 including the basic unit 22, particularly at two positions corresponding to the respective two side surfaces of the basic unit 22 (side surfaces opposite to each other in the direction of movement of the laminar member 11), whereby the plurality of film capacitor elements 12 are successively obtained. Each of the thus obtained film capacitor elements 12 is constituted by the basic unit 22 and the first and second protective films 24a and 24b which have the same length as the basic unit 22 and which are superposed on the respective lower and upper surfaces of the basic unit 22.

To produce the film capacitor 10 by using the thus obtained plurality of film capacitor elements 12, each film capacitor element 12 obtained as described above is sucked and held by the sucking pad 70 of the laminating device 56, and moved onto the table 72 by moving the sucking pad 70 with the movable arm 68. A predetermined number of the film capacitor elements 12 (three film capacitor elements 12 in this specific example) are moved onto the table 72 and superposed on each other, whereby the stack 14 of the predetermined number of the film capacitor elements 12 superposed on each other is obtained.

After the thus obtained stack 14 is subjected to a heat aging treatment as necessary, the external electrodes 18 are formed on the two side surfaces 16a and 16b of the stack 14, as shown in FIG. 5, by using the external-electrode forming device (external-electrode forming means) not shown including the thermal-spraying nozzle 42 for performing thermal spraying with respect to the side surfaces 16a and 16b of the stack 14. The external-electrode forming device is configured to form the external electrodes 18 on the two side surfaces 16a and 16b of the stack 14, such that one of the external electrodes 18 bridges the side surfaces 34a of the adjacent film capacitor elements 12, and the other external electrode 18 bridges the side surfaces 34b of the adjacent film capacitor elements 12, and such that the entireties of the side surfaces 16a and 16b of the stack 14 are covered by the external electrodes 18. Thus, the intended film capacitor 10 is obtained.

According to the process of this embodiment using the production device of the film capacitor 10 including the above-described production device 44 of the film capacitor element 12 and the above-described external-electrode forming device, plural kinds of film capacitor 10 having respective different capacitance values can be more efficiently produced by merely changing the number of the film capacitor elements 12 superposed on each other by the laminating device 56, without changing the production equipment or employing new production equipment. Further, in the produced film capacitor 10, progress of the insulation breakdown in the direction of its thickness can be effectively prevented.

Further, the process of this embodiment permits automated production of the plurality of film capacitor elements 12, to advantageously improve efficiency of production of the film capacitor elements 12 and the film capacitor 10.

In the process of this embodiment, the first and second protective films 24a and 24b are utilized as members for carrying the basic units 22 to the position at which the film capacitor elements 12 are formed from the laminar member consisting of the first and second protective films 24a and 24b and the basic units 22. Accordingly, the automated production of the film capacitor elements 12 and the film capacitor 10 can be more efficiently performed at a low cost.

During the automated production of the plurality of film capacitor elements 12 by the process of this embodiment, a pressure is applied to the laminar member consisting of the first and second protective films 24a and 24b and the basic units 22, so that the laminar member is pressed into the form of a flat sheet, whereby adhesiveness between the mutually superposed film capacitor elements 12 and adhesiveness between the first and second protective films 24a, 24b and the basic units 22 can be effectively improved.

It is noted that a production device to produce the plurality of film capacitor elements 12 by utilizing the first and second protective films 24a and 24b as the members for carrying the basic units 22 as described above is not limited to the production device 44 of this embodiment which has the first and second feeding rollers 46 and 48, the basic-unit transferring device 50, the pressing device 52 and the two cutting blades 54.

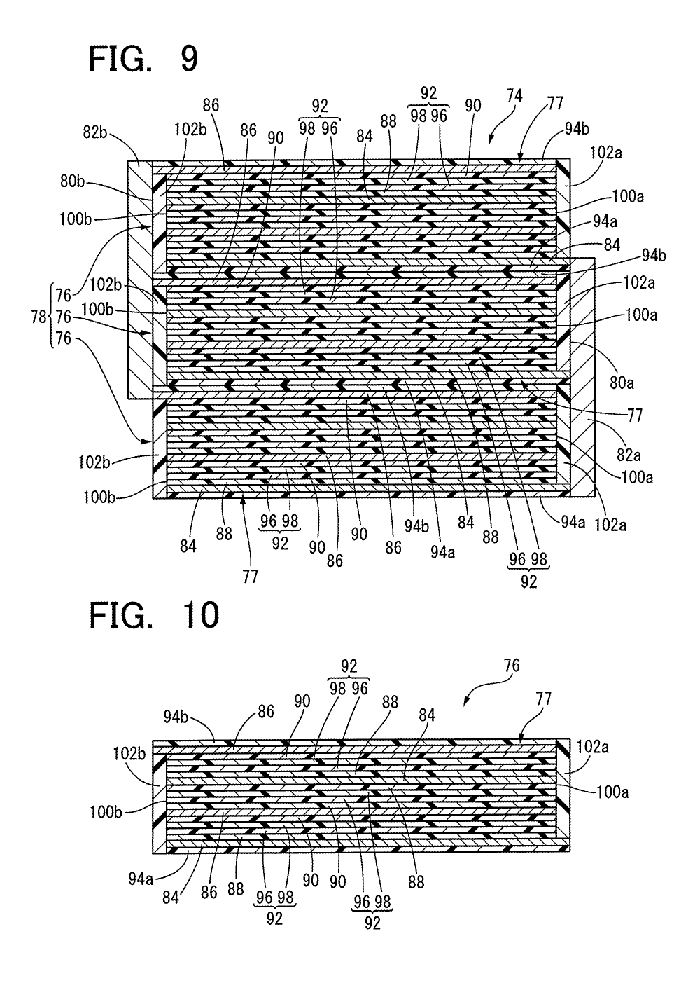

Referring next to the cross sectional view of FIG. 9, there is shown an all-solid lithium-ion secondary battery 74 as an electricity storage device having a structure according to another embodiment of the invention. As is apparent from FIG. 9, the all-solid lithium-ion secondary battery 74 (hereinafter simply referred to as the lithium-ion secondary battery 74) has three electricity storage elements in the form of cell elements 76. The lithium-ion secondary battery 74 is constituted by a stack 78 of the three cell elements 76 superposed on each other, and bus bars 82a and 82b which serve as external electrodes and which are provided on respective opposite two side surfaces 80a and 80b of the stack 78 as seen in the direction of the width of the stack 78 (right to left direction as seen in FIG. 9).

Described more specifically, each of the cell elements 76 of the lithium-ion secondary battery 74 of this embodiment has a plurality of positive-electrode collector layers 84 (two positive-electrode collector layers 84), a plurality of negative-electrode collector layers 86 (two negative-electrode collector layers 86), a plurality of positive-electrode layers 88 (three positive-electrode layers 88), a plurality of negative-electrode layers 90 (three negative-electrode layers 90), a plurality of solid electrolyte layers 92 (three solid electrolyte layers 92), and a first and second protective films 94a and 94b.

In this embodiment, the positive-electrode collector layers 84 are aluminum foils, while the negative-electrode collector layers 86 are copper foils. The materials of the positive-electrode collector layers 84 and the negative-electrode collector layers 86 are not particularly limited, and conventionally used materials are employed as the materials of those layers 84 and 86. Namely, the positive-electrode collector layers 84 and the negative-electrode collector layers 86 are formed by using metals such as aluminum, copper, titanium, nickel and iron, and alloys of those metals.

The positive-electrode layers 88 are constituted, for example, by a positive-electrode active substance (not shown) such as LiCoO₂ in the form of powder or particles, an auxiliary conductive agent such as acetylene black in the form of powder or a fluid, and a binder such as PVdF.

The negative-electrode layers 90 are constituted, for example, by a negative-electrode active substance (not shown) such as a natural graphite in the form of powder or particles, an auxiliary conductive agent such as acetylene black in the form of powder or a fluid, and a binder such as PVdF.

In this embodiment, each of the solid electrolyte layers 92 has a multilayer structure consisting of a first solid electrolyte portion 96 and a second solid electrolyte portion 98, which are thin resin films of polyethylene oxide. In this respect, it is noted that the first and second solid electrolyte portions 96 and 98 are not limited to the thin resin films of polyethylene oxide, and may be thin films of organic or inorganic materials conventionally used as the material of the solid electrolyte layer 92 of the lithium-ion secondary battery 74. The first and second solid electrolyte portions 96 and 98 may be formed of respective different materials. Further, the solid electrolyte layer 92 may have a single-layer structure.

In this embodiment, the first and second protective films 94a and 94b are thin resin films of polyethylene oxide. Although the material of the first and second protective films 94a and 94b is not particularly limited as long as the material has a high electric insulation property, the protective films 94a and 94b are generally formed of the same resin material as the binders in the positive-electrode layers 88 and the negative-electrode layers 90, or the same resin material as the solid electrolyte layers 92.

In each cell element 76 including the two positive-electrode collector layers 84 and the two negative-electrode collector layers 86, the positive-electrode and negative-electrode collector layers 84 and 86 are alternately arranged between the first and second protective films 94a and 94b. Between the adjacent positive-electrode collector layer 84 and the negative-electrode collector layer 86, the positive-electrode layer 88 and the negative-electrode layer 90 are disposed on the respective opposite sides of the solid electrolyte layer 92 consisting of the first and second solid electrolyte portions 96 and 98. Thus, each cell element 76 has a laminar structure in which the first and second protective films 94a and 94b are superposed on respective opposite surfaces of a basic unit 77 constituted by the plurality of positive-electrode and negative-electrode collector layers 84 and 86, the plurality of positive-electrode and negative-electrode layers 88 and 90, and the plurality of solid electrolyte layers 92, which are superposed on each other. It will be understood from the foregoing description that the positive-electrode collector layers 84 and the positive-electrode layers 88 constitute internal positive-electrode films, while the negative-electrode collector layers 86 and the negative-electrode layers 90 constitute internal negative-electrode films. In this respect, it is noted that the numbers of the positive-electrode and negative-electrode collector layers 84 and 86, the numbers of the positive-electrode and negative-electrode layers 88 and 90, and the number of the solid electrolyte layers 92, which layers 84, 86, 88, 90 and 92 are superposed on each other between the first and second protective films 94a and 94b, are not particularly limited.

In each cell element 76, the first and second protective films 94a and 94b, the positive-electrode collector layer 84 directly superposed on the first protective film 94a, and the negative-electrode collector layer 86 directly superposed on the second protective film 94b have a width which is larger, by a predetermined amount, than those of the other positive-electrode collector layers 84, the other negative-electrode collector layers 86 and the solid electrolyte layers 92. Widthwise end portions (on the right side as seen in FIG. 10) of the first protective film 94a and the positive-electrode collector layer 84 having the relatively large width laterally project from a side surface 100a of the cell element 76, while widthwise end portions (on the left side as seen in FIG. 10) of the second protective film 94b and the negative-electrode collector layer 86 having the relatively large width laterally project from the other side surface 100b of the cell element 76, which side surfaces 100a and 100b are opposite to each other in the direction of the width of the cell element 76.

Further, insulative films 102a and 102b having the electrical insulation property are bonded to the respective widthwise opposite side surfaces 100a and 100b of the cell element 76. The insulative film 102a bonded to the side surface 100a of the cell element 76 covers the entirety of the side surface 100a except the end faces of the above-described widthwise end portions of the first protective film 94a and the positive-electrode collector layer 84, which laterally project from the side surface 100a. On the other hand, the insulative film 102b bonded to the side surface 100b of the cell element 76 covers the entirety of the side surface 100b except the end faces of the above-described widthwise end portions of the second protective film 94b and the negative-electrode collector layer 86, which laterally project from the side surface 100b. Thus, the insulative films 102a and 102b assure electrical insulation of: the positive-electrode collector layers 84 other than the layer 84 directly superposed on the first protective film 94a; the negative-electrode collector layers 86 other than the layer 86 directly superposed on the second protective film 94b; and all positive-electrode and negative-electrode layers 88 and 90.

As shown in FIG. 9, the three cell elements 76 each constructed as described above are superposed on each other in the direction of superposition of the positive-electrode and negative-electrode collector layers 84 and 86, the positive-electrode and negative-electrode layers 88 and 90, the solid electrolyte layers 92, and the first and second protective films 94a and 94b, to constitute the stack 78.

One of widthwise opposite side surfaces of the stack 78 (side surface 80a) is constituted by surfaces of the insulative films 102a bonded to the side surfaces 100a of the three cell elements 76, which surfaces are remote from the cell elements 76, and the end faces of the first protective films 94a and the positive-electrode collector layers 84, which laterally project from the side surfaces 100a of the cell elements 76. The other of the widthwise opposite side surfaces of the stack 78 (side surface 80b) is constituted by surfaces of the insulative films 102b bonded to the side surfaces 100b of the three cell elements 76, which surfaces are remote from the cell elements 76, and the end faces of the second protective films 94b and the negative-electrode collector layers 86, which laterally project from the side surfaces 100b of the cell elements 76.

The bus bar 82a is bonded to the side surface 80a of the stack 78, such that the bus bar 82a is held in contact with the end faces of the positive-electrode collector layers 84 of the three cell elements 76 and electrically connected to the positive-electrode collector layers 84 laterally projecting from the above-described side surface 100a. On the other hand, the bus bar 82b is bonded to the other side surface 80b of the stack 78, such that the bus bar 82b is held in contact with the end faces of the negative-electrode collector layers 86 of the three cell elements 76 and electrically connected to the negative-electrode collector layers 86 laterally projecting from the above-described side surface 100b. In other words, the bus bar 82a is formed so as to bridge the side surfaces 100a of the three cell elements 76 superposed on each other, while the bus bar 82b is formed so as to bridge the other side surfaces 100b of the three cell elements 76.

Thus, the lithium-ion secondary battery 74 of this embodiment is formed such that the three cell elements 76 are superposed on each other and electrically connected in series with each other.

The lithium-ion secondary battery 74 is produced by a process described below, for example.

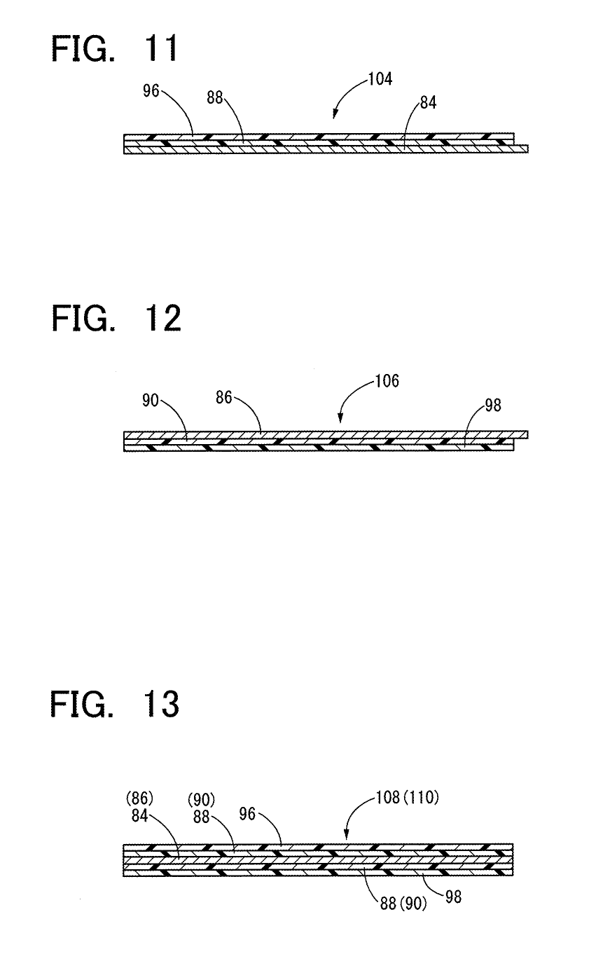

Initially, a plurality of cell elements 76 are produced. At this time, the first protective film 94a and the second protective film 94b which have the same width are provided. On the other hand, a plurality of first laminar films 104 shown in FIG. 11, a plurality of second laminar films 106 shown in FIG. 12, a plurality of third laminar films 108 and a plurality of fourth laminar films 110, which laminar films 108 and 110 are shown in FIG. 13, are produced.

The first laminar film 104 shown in FIG. 11 has a structure in which the positive-electrode layer 88 and the first solid electrolyte portion 96 which have a smaller width than the positive-electrode collector layer 84 having the same width as the first protective film 94a are superposed in this order of description on one of opposite major surfaces of the positive-electrode collector layer 84.

To produce the first laminar film 104, a metallic foil such as an aluminum foil having the same width as the first protective film 94a is provided as the positive-electrode collector layer 84. Then, the positive-electrode layer 88 is formed on the above-indicated one of the opposite major surfaces of the positive-electrode collector layer 84, by a known process. Then, the first solid electrolyte portion 96 is formed on the positive-electrode layer 88, by a known process. In this respect, it is noted that the positive-electrode collector layer 84 may be a vapor-deposited metal film formed by a known vapor-deposition process, a metallic sputtering film formed by sputtering, or a metallic CVD film formed by a CVD process, as well as the metallic foil.

The second laminar film 106 shown in FIG. 12 has a structure in which the negative-electrode layer 88 and the second solid electrolyte portion 98 which have a smaller width than the negative-electrode collector layer 86 having the same width as the second protective film 94b are superposed in this order of description on one of opposite major surfaces of the negative-electrode collector layer 86.

To produce the second laminar film 106, a metallic foil such as a copper foil having the same width as the second protective film 94b is provided as the negative-electrode collector layer 86. Then, the negative-electrode layer 90 is formed on the negative-electrode collector layer 86, by a known process. Then, the second solid electrolyte portion 98 is formed on the negative-electrode layer 90, by a known process. In this respect, it is noted that like the positive-electrode collector layer 84, the negative-electrode collector layer 86 may be a vapor-deposited metal film formed by a known vapor-deposition process, a metallic sputtering film formed by sputtering, or a metallic CVD film formed by a CVD process, as well as the metallic foil.

The third laminar film 108 shown in FIG. 13 has a structure in which the two positive-electrode layers 88 having the same width as the positive-electrode collector layer 84 are formed on the respective opposite major surfaces of the positive-electrode collector layer 84 having a width which is smaller by a predetermined amount than that of the first and second protective films 94a and 94b, and the first solid electrolyte portion 96 is formed on one of the two positive-electrode layers 88, while the second solid electrolyte portion 98 is formed on the other of the two positive-electrode layers 88. On the other hand, the fourth laminar film 110 has a structure in which the two negative-electrode layers 90 having the same width as the negative-electrode collector layer 86 are formed on the respective opposite major surfaces of the negative-electrode collector layer 86 having a width which is smaller by a predetermined amount than that of the first and second protective films 94a and 94b, and the first solid electrolyte portion 96 is formed on one of the two negative-electrode layers 90, while the second solid electrolyte portion 98 is formed on the other of the two negative-electrode layers 90. The third and fourth laminar films 108 and 110 are produced by a process similar to that for producing the first and second laminar films 104 and 106.

After the plurality of first and second protective films 94a and 94b and the plurality of first through fourth laminar films 104, 106, 108 and 110 are provided, the first laminar film 104, the third laminar film 108, the fourth laminar film 110 and the second laminar film 106 are superposed on each other in this order of description, whereby the basic unit 77 is obtained. Then, the first protective film 94a is superposed on a surface of the first laminar film 104 remote from the third laminar film 108, while the second protective film 94b is superposed on a surface of the second laminar film 106 remote from the fourth laminar film 110. At this time, the first and second protective films 94a and 94b and the first and second laminar films 104 and 106 are arranged such that end portions of the first protective film 94a and the positive-electrode collector layer 84 of the first laminar film 104 laterally project from the side surface 100a of the basic unit 77, while end portions of the second protective film 94b and the negative-electrode collector layer 86 of the second laminar film 106 laterally project from the side surface 100b of the basic unit 77. Thus, a stack of the first and second protective films 94a and 94b and the basic unit 77 is obtained.

Then, insulative films 102a and 102b are formed on the respective opposite side surfaces 100a and 100b of the thus obtained stack of the first and second protective films 94a and 94b and the basic unit 77, such that the end faces of the first and second protective films 94a and 94b and the positive-electrode collector layer 84 of the first laminar film 104 and the negative-electrode collector layer 86 of the second laminar film 106 are laterally exposed. The insulative films 102a and 102b are formed by coating the side surfaces 100a and 100b with a solution of a resin material of the insulative films 102a and 102b, and solidifying the thus formed coating layers, for example. Thus, the cell element 76 having the structure shown in FIG. 10 is obtained. The plurality of cell elements 76 are produced as described above.

Then, the stack 78 is obtained by superposing three of the plurality of cell elements 76 on each other by a process similar to that shown in FIG. 4. In the thus obtained stack 78, the first and second protective films 94a and 94b superposed on each other are disposed between the adjacent cell elements 76, and the positive-electrode collector layer 84 and the negative-electrode collector layer 86 are disposed on respective opposite sides of the above-described first and second protective films 94a and 94b.

Then, the bus bars 80a and 80b in the form of flat metallic sheets such as zinc sheets are bonded to the respective two side surfaces 80a and 80b of the stack 78, as shown in FIG. 9. One of the bus bars (bus bar 82a) is bonded to the three insulative films 102a with a bonding agent or the like, such that the bus bar 82a is held in contact with the end faces of the three positive-electrode collector layers 84 exposed at one of the two side surfaces (side surface 80a) of the stack 78. The other bus bar 82b is bonded to the three insulative films 102b with a bonding agent or the like, such that the bus bar 82b is held in contact with the end faces of the three negative-electrode collector layers 86 exposed at the other side surface 80b of the stack 78. Thus, one of the bus bars (bus bar 80a) is formed so as to bridge the side surfaces 100a of the three cell elements 76, while the other bus bar 80b is formed so as to bridge the other side surfaces 100b of the three cell elements 76.

Thus, the intended lithium-ion secondary battery 74 having the structure shown in FIG. 9 is obtained. In this respect, it is noted that the lithium-ion secondary battery 74 having a capacitance different from that of the lithium-ion secondary battery 74 shown in FIG. 9 can be obtained by adequately changing the number of the cell elements 76 superposed on each other and performing a process similar to that described above.

It will be understood from the foregoing description that the capacitance of the lithium-ion secondary battery 74 of this embodiment can be controlled by merely increasing or reducing the number of the cell elements 76 selected to form the stack 78 from the plurality of cell elements 76 produced beforehand, with the same numbers of the third and fourth laminar films 108 and 110, namely, without changing the numbers of the third and fourth laminar films 108 and 110 constituting each of the cell elements 76.

The structure of the lithium-ion secondary battery 74 of this embodiment permits extremely easy and efficient production of plural kinds of lithium-ion secondary battery 74 having respective different capacitance values without a need to change the production equipment or employ new production equipment.

Additionally, in the lithium-ion secondary battery 74 of this embodiment, the two protective films 24a and 24b superposed on each other are disposed between the adjacent cell elements 76. Therefore, when insulation breakdown takes place in any one of the plurality of cell elements 76 superposed on each other, the insulation breakdown is stopped by the two protective films 24a and 24b superposed on each other and having a sufficiently large thickness as a whole, to prevent progress of the insulation breakdown into another cell element 76. Accordingly, a higher degree of durability of the lithium-ion secondary battery 74 can be effectively secured.

The lithium-ion secondary battery 74 can be produced by using the production device 44 which is used in the production of the film capacitor 10 and which has the structure shown in FIG. 8, for example. Namely, the production device 44 can also be used as a device for producing the lithium-ion secondary battery 74.

To produce the lithium-ion secondary battery 74 by using the production device 44, the first through fourth laminar films 104, 106, 108 and 110 shown in FIGS. 11-13 are superposed on each other in the order shown in FIG. 10, to obtain the basic unit 77 in which the plurality of positive-electrode and negative-electrode collector layers 84 and 86, the plurality of positive-electrode and negative-electrode layers 88 and 90, and the plurality of solid electrolyte layers 92 are superposed on each other in the order shown in FIG. 10. The plurality of basic units 77 are produced.

By using the thus obtained plurality of basic units 77, elongate strips of the first and second protective films 94a and 94b and the production device 44 shown in FIG. 8, the plurality of cell elements 76 are successively produced by a process similar to that described above with respect to the production of the plurality of film capacitor elements 12. In the process for producing the cell elements 76, a pressure is applied by the pressing device 52 to portions of the laminar member 11 constituted by the basic units 77 (22) and the first and second protective films 94a and 94b (24a, 24b), in which portions the basic units 77 (22) are present, whereby adhesiveness between the layers of each basic unit 77 (22) and adhesiveness between the basic units 77 (22) and the first and second protective films 94a and 94b (24a, 24b) are advantageously increased.

After three of the successively produced plurality of cell elements 76 are superposed on each other by the laminating device 56, the insulative films 102a and 102b are formed on the respective side surfaces 100a and 100b of the cell elements 76, whereby the stack 78 is obtained. Subsequently, the bus bars 82a and 82b are formed on the respective two side surfaces 80a and 80b of the stack 78, whereby the intended lithium-ion secondary battery 74 is obtained.

According to the above-described process for producing the lithium-ion secondary battery 74 by using the production device 44, the intended lithium-ion secondary battery 74 can be more rapidly and more efficiently produced.

Although the specific embodiments of the invention have been described for illustrative purpose only, the invention is by no means limited to the details of the illustrated embodiments.

For instance, it is not necessary that all of the plurality of film capacitor elements 12 of the film capacitor 10 have the same number of the metallized films 20. The number of the metallized films 20 of at least one of those plurality of film capacitor elements 12 may be different from that of the other film capacitor elements 12. Also, it is not necessary that all of the plurality of cell elements 76 of the lithium-ion secondary battery 74 have the same numbers of the third and fourth laminar films 108 and 110. The numbers of the third and fourth laminar films 108 and 110 of at least one of the plurality of cell elements 76 may be different from those of the other cell elements 76.

Accordingly, in the production of the film capacitor 10 and production of the lithium-ion secondary battery 74, it is possible to select plural kinds of the film capacitor element 12 having respective different numbers of the metallized films 20, and to select plural kinds of the cell element 76 having respective different numbers of the third and fourth laminar films 108 and 110.

Further, the plurality of film capacitor elements 12 of the film capacitor 10 may have a structure in which the first and second protective films 24a and 24b are superposed on respective opposite surfaces of a basic unit obtained by alternately superposing dielectric films in the form of vapor-deposited polymer films and vapor-deposited metal films on each other, in place of the structure in which the first and second protective films 24a and 24b are superposed on the respective opposite surfaces of the basic unit 22 obtained by superposing the metallized films 20 on each other.

In the case where the film capacitor elements 12 have the structure having the basic unit 22 obtained by superposing the metallized films 20 on each other, each of the metallized films 20 may consist of the resin film 26 and the vapor-deposited metal films 28 formed on the respective opposite major surfaces of the resin film 26.

It is possible to produce the film capacitor 10 by covering the stack 14 of the plurality of film capacitor elements 12 with protective films other than the first and second protective films 24a and 24b, and forming the external electrodes on two side surfaces of the stack 14 covered with the above-described other protective films.

In the production of the cell elements 76 of the lithium-ion secondary battery 74, it is possible to produce each cell element 76 by superposing, on the first protective film 94a, required numbers of the positive-electrode and negative-electrode collector layers 84 and 86, positive-electrode and negative-electrode layers 88 and 90, and solid electrolyte layers 92 (first and second solid electrolyte portions 96 and 98), which are separate from each other, and superposing the second protective film 94b on the thus obtained stack, without using the first through fourth laminar films 104, 106, 108 and 110. Further, the solid electrolyte layers 92 of each cell element 76 may be vapor-deposited polymer films.

In the above-described embodiments, the specific examples of the invention applied to the film capacitor, the lithium-ion secondary battery and processes for producing the film capacitor and the lithium-ion secondary battery were described. However, it goes without saying that the invention is also advantageously applicable to electricity storage devices other than the film capacitor and the lithium-ion secondary battery, such as an all-solid secondary battery and an air secondary battery which are produced by using lithium, magnesium, calcium, iron, zinc and the like as positive-electrode active substances, negative-electrode active substances and electrodes. Also, the invention is advantageously applicable to processes for producing such electricity storage devices.

It goes without saying that the invention may be embodied with various other changes, modifications and improvements which are not illustrated herein and which may occur to those skilled in the art, without departing from the spirit of the invention, and that those changes, modifications and improvements are also within the scope of the invention.

1. A film capacitor characterized in that the film capacitor is constituted by a stack of a plurality of film capacitor elements superposed on each other and two external electrodes formed on respective opposite side surfaces of the stack, wherein each of the plurality of film capacitor elements has a basic unit obtained by alternately superposing at least one dielectric film and a plurality of vapor-deposited metal films on each other, and two protective films which have an electrical insulation property and which are superposed on respective opposite surfaces of the basic unit as seen in a direction of superposition of the at least one dielectric film and the plurality of vapor-deposited metal films, and the two external electrodes are formed so as to bridge corresponding side surfaces of adjacent ones of the plurality of film capacitor elements.

2. The film capacitor according to claim 1, wherein gaps are formed in the respective opposite side surfaces of the stack of the plurality of film capacitor elements, such that the gaps are open outwards and parts of the vapor-deposited metal films are exposed to the outside of the stack through the gaps, and
portions of the two external electrodes formed on the respective opposite side surfaces of the stack fill the gaps, and
the portions of one of the two external electrodes filling the gaps formed in one of said respective opposite side surfaces of the stack are defined as first connecting portions connecting said one external electrode formed on said one side surface of the stack to the parts of the vapor-deposited metal films exposed to the gaps, while
the portions of the other external electrode filling the gaps formed in the other of said respective opposite side surfaces of the stack are defined as second connecting portions connecting said other external electrode formed on said other side surface of the stack to the parts of the vapor-deposited metal films exposed to the gaps, wherein
said first connecting portions and said second connecting portions are alternately arranged as seen in the direction of superposition of the plurality of film capacitor elements constituting the stack.

3. A process for producing a film capacitor, characterized by comprising the steps of:
providing a plurality of film capacitor elements each obtained by using a basic unit having a structure in which at least one dielectric film and a plurality of vapor-deposited metal films are alternately superposed on each other, and superposing two protective films having an electrical insulation property on respective opposite surfaces of the basic unit as seen in a direction of superposition of the at least one dielectric film and the plurality of vapor-deposited metal films;
selecting at least two film capacitor elements from the thus provided plurality of film capacitor elements;
superposing the selected at least two film capacitor elements on each other to form a stack of those film capacitor elements; and
forming two external electrodes on respective opposite side surfaces of the stack, such that the external electrodes bridge corresponding side surfaces of adjacent ones of the at least two film capacitor elements.

4. The process for producing the film capacitor according to claim 3, wherein the step of providing the plurality of film capacitor elements comprises:
continuously moving a first strip member giving one of the two protective films superposed on the respective opposite surfaces of the basic unit, in a longitudinal direction of the first strip member;
placing a plurality of basic units on the first strip member being continuously moved, such that one of the respective opposite surfaces of each basic unit as seen in the direction of superposition of the at least one dielectric film and the plurality of vapor-deposited metal films is in contact with the first strip member, and such that the plurality of basic units are spaced apart from each other by a predetermined distance in the direction of movement of the first strip member;
continuously moving a second strip member giving the other of said two protective films in a longitudinal direction of the second strip member, such that the second strip member covers the plurality of basic units placed on the first strip member, whereby the plurality of basic units held between the first and second strip members are continuously carried by the first and second strip members; and
cutting the first and second strip members at positions on respective upstream and downstream sides of each of the plurality of basic units as seen in the direction of movements of the first and second strip members, thereby successively producing the plurality of film capacitor elements.

5. The process for producing the film capacitor according to claim 4, wherein a pressure is applied to a laminar member consisting of the first and second strip members and the plurality of basic units held between the first and second strip members while the laminar member is continuously carried, before the first and second strip members are cut.

6. A device for producing a film capacitor, characterized by comprising:
film-capacitor-element forming means for forming each of a plurality of film capacitor elements by using a basic unit obtained by alternately superposing at least one dielectric film and a plurality of vapor-deposited metal films on each other, and superposing two protective films having an electrical insulation property on respective opposite surfaces of the basic unit as seen in a direction of superposition of the at least one dielectric film and the plurality of vapor-deposited metal films;
stack forming means for superposing at least two of the thus formed plurality of film capacitor elements on each other, thereby forming a stack of the at least two film capacitor elements; and
external-electrode forming means for forming two external electrodes on respective opposite side surfaces of the stack, such that the external electrodes bridge corresponding side surfaces of adjacent ones of the at least two film capacitor elements.

7. The device for producing the film capacitor according to claim 6, wherein the film-capacitor-element forming means comprises:
(a) first moving means for continuously moving a first strip member giving one of the two protective films superposed on the respective opposite surfaces of the basic unit, in a longitudinal direction of the first strip member;
(b) placing means for placing the plurality of basic units on the first strip member being continuously moved, such that one of the respective opposite surfaces of each basic unit as seen in the direction of superposition of the at least one dielectric film and the plurality of vapor-deposited metal films is in contact with the first strip member, and such that the plurality of basic units are spaced apart from each other by a predetermined distance in the direction of movement of the first strip member;
(c) second moving means for continuously moving a second strip member giving the other of said two protective films, such that the second strip member covers the plurality of basic units placed on the first strip member, whereby a laminar member consisting of the first and second strip members and the plurality of basic units interposed between the first and second strip members is carried by the first and second strip members in the direction of movements of the first and second strip members; and
(d) cutting means for cutting the first and second strip members at positions between adjacent basic units of the laminar member, so that each of the thus cut pieces of the laminar member is obtained as each of the plurality of film capacitor elements.

8. The device for producing the film capacitor according to claim 7, wherein the film-capacitor-element forming means further comprises pressing means for applying a pressure to the laminar member, which pressing means is disposed on an upstream side of the cutting means as seen in the direction of movements of the first and second strip members.
